(19) United States
(12) Patent Application Publication
(10) Pub. No.: US 2014/0043367 A1
(43) Pub. Date: Feb. 13, 2014

(54) STORAGE MEDIUM HAVING STORED THEREIN IMAGE DISPLAY PROGRAM, IMAGE DISPLAY APPARATUS, IMAGE DISPLAY SYSTEM, AND IMAGE DISPLAY METHOD

(71) Applicants: Masamichi SAKAINO, Kyoto (JP); Kojiro OOKI, Tokyo (JP); Haruka ITOH, Tokyo (JP)

(72) Inventors: Masamichi SAKAINO, Kyoto (JP); Kojiro OOKI, Tokyo (JP); Haruka ITOH, Tokyo (JP)

(73) Assignees: HAL Laboratory, Inc., Tokyo (JP); Nintendo Co., Ltd., Kyoto (JP)

(21) Appl. No.: 13/785,506

(22) Filed: Mar. 5, 2013

(30) Foreign Application Priority Data
Aug. 7, 2012 (JP) 2012-174578

(51) Int. Cl. G06T 11/60

(52) U.S. Cl. CPC G06T 11/60
USPC 345/647

(57) ABSTRACT

An input provided by a user is received from an input apparatus, and in accordance with the input, a current display position of an operation handler image to be displayed on the display apparatus is set. In accordance with the current display position of the operation handler image, a setting of information regarding an operation target to be operated by the user is changed, and a display position of the operation handler image used when the setting has been changed is retained. Then, the operation handler image is displayed on the display apparatus at the set current display position, and a past position image indicating at least one of the retained past display positions is displayed on the display apparatus.

### CROSS REFERENCE TO RELATED APPLICATION

The disclosure of Japanese Patent Application No. 2012-174578, filed on Aug. 7, 2012, is incorporated herein by reference.

### FIELD

The technology shown here relates to a storage medium having stored therein an image display program that makes a setting of an operation target in accordance with an input of an operation, an image display apparatus, an image display system, and an image display method that make a setting of an operation target in accordance with an input of an operation.

### BACKGROUND AND SUMMARY

Conventionally, there is a technique of making the settings of an operation target in accordance with an input of an operation. For example, there is a technique of: displaying a slider capable of moving in accordance with an input of an operation; and adjusting the brightness, the saturation, and the like of an image in accordance with the position of the slider, thereby editing the image.

The above technique enables the editing of the image on the basis of the position of the slider. If, however, having edited the image, the above technique has difficulty returning the image to the state before the editing.

The exemplary embodiment can employ, for example, the following configurations. It should be noted that it is understood that, to interpret the descriptions of the claims, the scope of the claims should be interpreted only by the descriptions of the claims. If there is a conflict between the descriptions of the claims and the descriptions of the specification, the descriptions of the claims take precedence.

An exemplary configuration of an image display apparatus according to the exemplary embodiment is an image display apparatus for displaying on a display apparatus an image based on an input. The image display apparatus includes an input reception unit, a current display position setting unit, a setting change unit, a past display position retention unit, and a display control unit. The input reception unit receives from an input apparatus an input provided by a user. The current display position setting unit, in accordance with the input, sets a current display position of a slider to be displayed on the display apparatus. The setting change unit, in accordance with the current display position of the slider, changes a setting of at least one of a placement position, a placement direction, a size, and a shape of at least one part forming a virtual object. The past display position retention unit retains a past display position of the slider used when the setting change unit has changed the setting. The display control unit causes the slider to be displayed on the display apparatus at the current display position set by the current display position setting unit, and causes a past position image distinguishable from the slider to be displayed on the display apparatus at the past display position retained by the past display position retention unit.

An exemplary configuration of a computer-readable storage medium having stored therein an image display program according to the exemplary embodiment is a computer-readable storage medium having stored therein an image display program to be executed by a computer of an apparatus for displaying on a display apparatus an image based on an input. The image display program causes the computer to execute: receiving from an input apparatus an input provided by a user; in accordance with the input, setting a current display position of an operation handler image to be displayed on the display apparatus; in accordance with the current display position of the operation handler image, changing a setting of information regarding an operation target to be operated by the user; retaining a display position of the operation handler image used when the setting has been changed; and causing the operation handler image to be displayed on the display apparatus at the current display position, and causing a past position image indicating at least one of the retained past display positions to be displayed on the display apparatus.

In addition, the operation target may be a virtual object that is displayed on the display apparatus.

In addition, the operation target may be allowed to be edited and/or created on the basis of the received input provided by the user.

In addition, an image representing the operation target indicating a result of changing the setting in accordance with the current display position of the operation handler image currently displayed on the display apparatus may be further displayed on the display apparatus.

In addition, at least every time an input provided by the user is received, the image representing the operation target of which the setting has been changed in accordance with the input provided by the user may be displayed on the display apparatus.

In addition, the operation target may be formed of a plurality of parts. The current display position of the operation handler image to be displayed on the display apparatus may be set with respect to each of the plurality of parts. The setting of information regarding the operation target may be changed with respect to each of the plurality of parts. The display position of the operation handler image used when the setting of the information has been changed may be retained with respect to each of the plurality of parts. The operation handler image and the past position image corresponding to at least one of the plurality of parts may be displayed on the display apparatus.

In addition, the retained display position may be a position at which the operation handler image has been displayed when the user has changed the setting of the information regarding the operation target and thereafter confirmed the setting in the past.

In addition, the image display program may further cause the computer to execute, in accordance with the input, confirming the changed setting of the information regarding the operation target. In this case, a display position of the operation handler image for obtaining the confirmed setting may be retained. The past position image at the display position retained for the setting confirmed before the setting of the information regarding the operation target is changed may be displayed together with the operation handler image on the display apparatus.

In addition, the past position image may be an image distinguishable from the operation handler image.

In addition, the past position image may be an image representing a mark of the operation handler image having been displayed.

In addition, in accordance with the input, the display position may be moved on a two-dimensional plane displayed on the display apparatus. In accordance with the current display position, of the operation handler image, corresponding to two axes defined on the two-dimensional plane, a plurality of settings may be changed for the information regarding the operation target.

In addition, in accordance with a predetermined input, the retained past display position may be set as the current display position of the operation handler image.

In addition, the operation target may be an operation target image that is displayed on the display apparatus. In this case, in accordance with the current display position of the operation handler image, a setting of at least one of a placement position, a placement direction, a size, and a shape of at least one part forming the operation target image may be changed.

In addition, the exemplary embodiment may be carried out in the forms of an image display apparatus and an image display system that include units for performing the above processes, and an image display method including the above operations performed by the above processes.

These and other objects, features, aspects and advantages of the exemplary embodiment will become more apparent from the following detailed description of the exemplary embodiment when taken in conjunction with the accompanying drawings.

### BRIEF DESCRIPTION OF THE DRAWINGS

FIG. 1 is a diagram showing a non-limiting example of a system including an image display apparatus according to an exemplary embodiment;

FIG. 2 is a diagram showing a non-limiting example of an image displayed when a character image PC is edited;

FIG. 3 is a diagram showing a non-limiting example of an image displayed when the up-down position of an eye image PCe is edited;

FIG. 4 is a diagram showing a non-limiting example of an image displayed when the space in the eye image PCe is edited;

FIG. 5 is a diagram showing a non-limiting example of an image displayed when the build of the character image PC is edited;

FIG. 6 is a diagram showing another non-limiting example of the image displayed when the build of the character image PC is edited;

FIG. 7 is a diagram showing non-limiting examples of main data and programs stored in a storage section 32; and

FIG. 8 is a flow chart showing a non-limiting example of the processing performed by an information processing apparatus 3.

### DETAILED DESCRIPTION OF NON-LIMITING EXAMPLE EMBODIMENTS

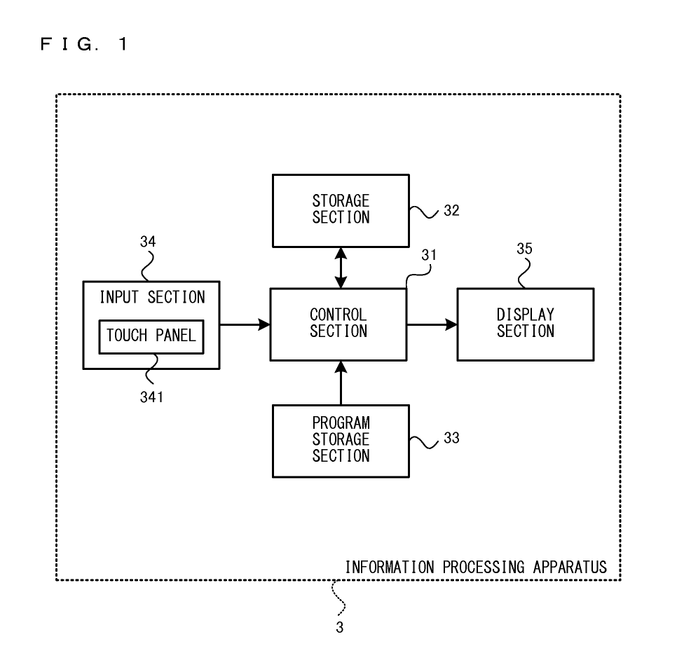

With reference to FIG. 1, an image display apparatus according to an exemplary embodiment is described. For example, the image display apparatus includes, as an example, an information processing apparatus 3. For example, the information processing apparatus 3 can execute an image display program stored in a storage medium such as an exchangeable optical disk, or received from another apparatus. The information processing apparatus 3 may be a device such as a general personal computer, a stationary game apparatus, a mobile phone, a handheld game apparatus, or a PDA (Personal Digital Assistant). FIG. 1 is a block diagram showing an example of the configuration of the information processing apparatus 3.

In FIG. 1, the information processing apparatus 3 includes a control section 31, a storage section 32, a program storage section 33, an input section 34, and a display section 35. The information processing apparatus 3 may include one or more apparatuses containing: an information processing apparatus having at least the control section 31; and another apparatus.

The control section 31 is information processing means (a computer) for performing various types of information processing, and is, for example, a CPU. The control section 31 has the functions of performing as the various types of information processing processing based on the operation performed on the input section 34 by a user; and the like. The above functions of the control section 31 are achieved, for example, as a result of the CPU executing a predetermined program.

The storage section 32 stores various data to be used when the control section 31 performs the above information processing. The storage section 32 is, for example, a memory accessible by the CPU (the control section 31).

The program storage section 33 stores a program. The program storage section 33 may be any storage device (storage medium) accessible by the control section 31. For example, the program storage section 33 may be a storage device provided in the information processing apparatus having the control section 31, or may be a storage medium detachably attached to the information processing apparatus having the control section 31. Alternatively, the program storage section 33 may be a storage device (a server or the like) connected to the control section 31 via a network. The control section 31 (the CPU) may read some or all of the program to the storage section 32 at appropriate timing, and execute the read program.

The input section 34 is input means that can be operated by the user. The input section 34 may be any input apparatus. For example, the input section 34 has a touch panel 341. The touch panel 341 detects the position of the input provided to a predetermined input surface (a display screen of the display section 35). Further, the information processing apparatus 3 may include an operation section such as a slide pad, a directional pad, and an operation button as the input section 34.

The display section 35 displays an image in accordance with an instruction from the control section 31.

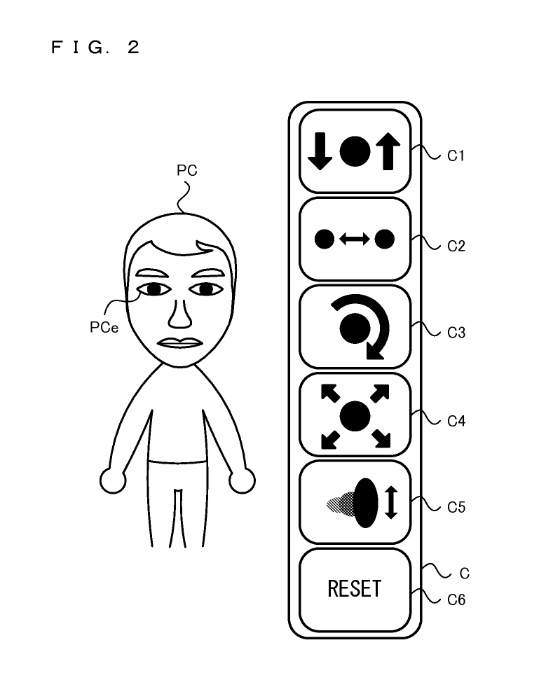

Next, with reference to FIGS. 2 through 6, a description is given of an overview of the processing performed by the information processing apparatus 3, before the description of specific processing performed by the information processing apparatus 3. The following descriptions are given taking as an example the process of editing a character image PC. Further, FIGS. 2 through 6 are diagrams each showing an example of an image displayed on the display section 35 of the information processing apparatus 3 when the character image PC is edited.

For example, the process of editing the character image PC is performed in an application where the user creates a character representing the user themselves or an acquaintance. As an example, in the application, after a default character is presented, the user edits the default character by changing and adjusting each part of the default character so as to resemble the user themselves or an acquaintance, thereby creating a character.

For example, the user selects each part of the character image PC and edits the character image PC displayed on the display section 35 by adjusting the placement position, the placement direction, the size, the shape, or the like of the part. FIG. 2 is examples of images representing options presented when the placement position, the placement direction, the size, the shape, or the like of an eye image PCe of the character image PC is adjusted. As shown in FIG. 2, the following are displayed on the display section 35 as options C for editing the eye image PCe: an up-down position adjustment button C1; a space adjustment button C2; an angle adjustment button C3; a size adjustment button C4; a flattening adjustment button C5; and a reset button C6. Further, the character image PC based on the current setting states is also displayed on the display section 35. Then, the user performs via the touch panel 341 a touch operation on a position overlapping a desired button image, and thereby can select an item to be edited from among the options C.

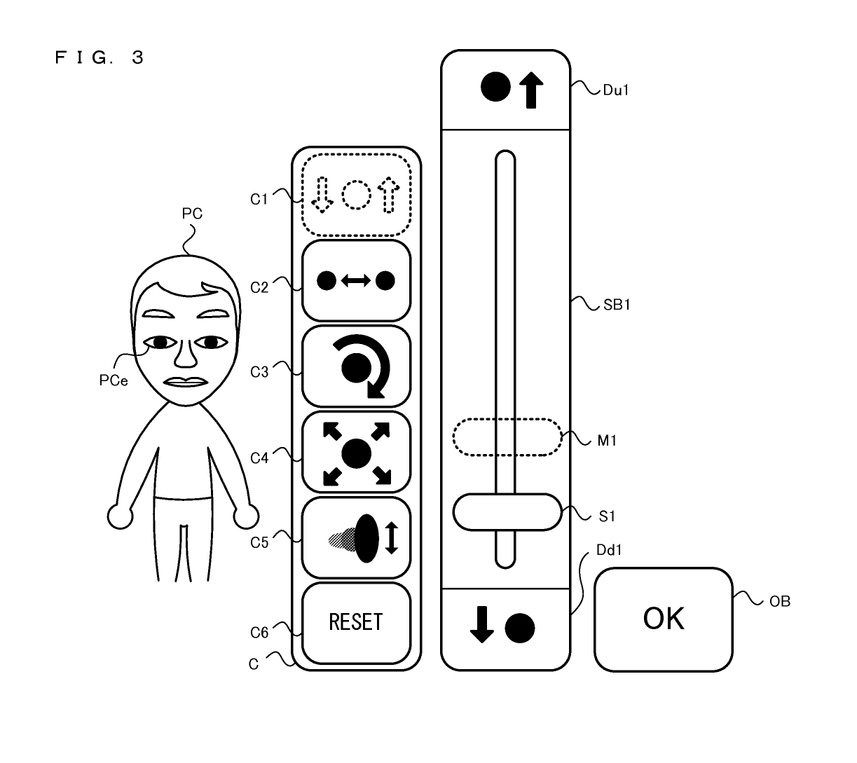

As shown in FIG. 3, if the up-down position adjustment button C1 has been selected, the up-down position adjustment button C1 is displayed in a display form different from the other buttons (for example, displayed in a pale manner or displayed in a different hue), and a slider bar SB1 appears near the up-down position adjustment button C1. The slider bar SB1 has an operation handler (a slider S1) capable of moving in the up-down direction in accordance with the touch operation on the touch panel 341. Then, it is possible to move the position of the eye image PCe upward by moving the position of the slider S1 upward, and move the position of the eye image PCe downward by moving the position of the slider S1 downward. As is clear from the comparison with the character image PC shown in FIG. 2, the character image PC is displayed on an eye-image-PCe up-down position adjustment screen (FIG. 3) such that the eye image PCe is moved in accordance with the up-down position of the slider S1. Further, at the upper end of the slider bar SB1, a guide sign Du1 is displayed that indicates that the placement position moves upward. At the lower end of the slider bar SB1, a guide sign Dd1 is displayed that indicates that the placement position moves downward. As shown in FIG. 3, the guide sign Du1 is displayed in a design suggesting that the object is moved upward, and the guide sign Dd1 is displayed in a design suggesting that the object is moved downward. It should be noted that, while the up-down position adjustment button C1 is displayed in a design suggesting that the object is moved upward or downward, the designs of the guide sign Du1 and the guide sign Dd1 are created by extracting parts of the design of the up-down position adjustment button C1, which enables an intuitive operation.

Here, in the slider bar SB1, a mark M1 is displayed that indicates the position of the slider S1 when the up-down position adjustment button C1 has been selected. That is, the mark M1 functions as a sign indicating the position of the slider S1 before the up-down position of the eye image PCe is adjusted. As an example, the mark M1 functions as a sign indicating the position of the slider S1 when determined by the previous editing operation (for example, determined by the operation of selecting an OK button OB). For example, the mark M1 is displayed as an image representing the shadow of the slider S1, or the like, but may be an image in another display form so long as it is an image distinguishable from the slider S1 and capable of indicating the position of the slider S1 set in the past. As described above, by viewing the mark M1, the user can easily know the setting made before the user themselves adjusts the up-down position of the eye image PCe. Further, if the user wishes to return the setting to that made before the user adjusts the up-down position of the eye image PCe, the user can easily return the setting by moving the slider S1 to the position indicated by the mark M1. For example, as a result of adjusting the up-down position of the eye image PCe by trial and error, the user may wish to return the setting to that made before the adjustment. In such a case, it is possible to suitably use the mark M1.

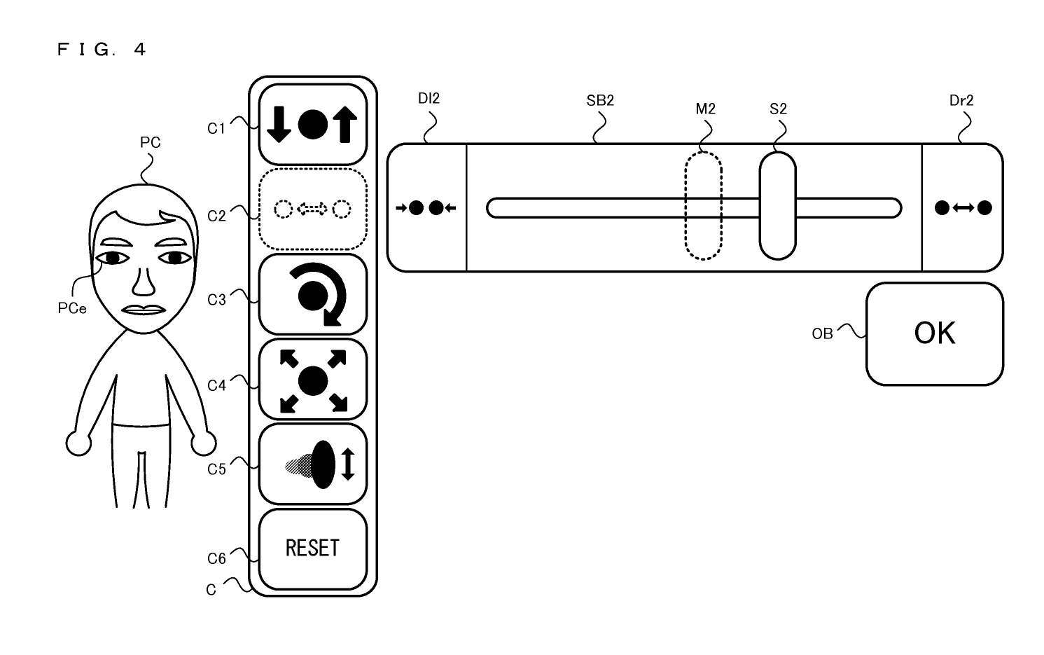

As shown in FIG. 4, if the space adjustment button C2 has been selected, the space adjustment button C2 is displayed in a display form different from the other buttons, and a slider bar SB2 appears near the space adjustment button C2. The slider bar SB2 has a slider S2 capable of moving in the left-right direction in accordance with the touch operation on the touch panel 341. Then, it is possible to move the eye image PCe so as to make the space between the eyes narrower, by moving the position of the slider S2 to the left. It is also possible to move the eye image PCe so as to make the space between the eyes wider, by moving the position of the slider S2 to the right. As is clear from the comparison with the character image PC shown in FIG. 2, the character image PC is displayed on an eye-image-PCe space adjustment screen (FIG. 4) such that the eye image PCe is moved in accordance with the left-right position of the slider S2. Further, at the left end of the slider bar SB2, a guide sign D12 is displayed that indicates that the space becomes narrower. At the right end of the slider bar SB2, a guide sign Dr2 is displayed that indicates that the space becomes wider. As shown in FIG. 4, the guide sign D12 is displayed in a design suggesting that the space in the object becomes narrower, and the guide sign Dr2 is displayed in a design suggesting that the space in the object becomes wider. It should be noted that, while the space adjustment button C2 is displayed in a design suggesting that the space in the object is widened, the guide sign Dr2 is created in the same design as that of the space adjustment button C2, and the guide sign D12 is created in a design suggesting the direction opposite to the direction suggested by the design of the space adjustment button C2, which enables an intuitive operation.

Here, in the slider bar SB2, a mark M2 is displayed that indicates the position of the slider S2 when the space adjustment button C2 has been selected. That is, the mark M2 functions as a sign indicating the position of the slider S2 before the space in the eye image PCe is adjusted. For example, also the mark M2 is displayed as an image representing the shadow of the slider S2, or the like, but may be an image in another display form so long as it is an image distinguishable from the slider S2 and capable of indicating the position of the slider S2 set in the past. As described above, by viewing the mark M2, the user can easily know the setting made before the user themselves adjusts the space in the eye image PCe, and can also easily return the setting to that made before the adjustment.

If the angle adjustment button C3 and the size adjustment button C4 have been selected, slider bars SB3 and SB4 are displayed on an angle adjustment screen and a size adjustment screen, respectively. Also the slider bars SB3 and SB4 make it possible to adjust the angle of rotation of the eye image PCe (eyes turned up at the corners or drooping eyes) and the size of the eye image PCe (reduction or enlargement) by moving sliders S3 and S4, respectively, in the left-right direction as in the slider bar SB2. Then, also in the slider bars SB3 and SB4, marks M3 and M4 are displayed that indicate the positions of the sliders S3 and S4 when the angle adjustment button C3 and the size adjustment button C4 have been selected, respectively. That is, the marks M3 and M4 function as signs indicating the positions of the sliders S3 and S4 before the angle of rotation and the size of the eye image PCe are adjusted, respectively. For example, also both the marks M3 and M4 are displayed as images representing the shadows of the sliders S3 and S4, or the like, but may be images in other display forms so long as they are images distinguishable from the sliders S3 and S4 and capable of indicating the positions of the sliders S3 and S4 set in the past, respectively. As described above, by viewing the mark M3 or M4, the user can easily know the setting made before the user themselves adjusts the angle of rotation or the size of the eye image PCe, and can also easily return the setting to that made before the adjustment.

In addition, if the flattening adjustment button C5 has been selected, a slider bar SB5 is displayed on a flattening adjustment screen. Also the slider bar SB5 makes it possible to adjust the flattening of the eye image PCe (vertically long or horizontally long) by moving a slider S5 in the up-down direction as in the slider bar SB1. Also in the slider bar SB5, a mark M5 is displayed that indicates the position of the slider S5 when the flattening adjustment button C5 has been selected. That is, the mark M5 functions as a sign indicating the position of the slider S5 before the flattening of the eye image PCe is adjusted. For example, also the mark M5 is displayed as an image representing the shadow of the slider S5, or the like, but may be an image in another display form so long as it is an image distinguishable from the slider S5 and capable of indicating the position of the slider S5 set in the past. As described above, by viewing the mark M5, the user can easily know the setting made before the user themselves adjusts the flattening of the eye image PCe, and can also easily return the setting to that made before the adjustment.

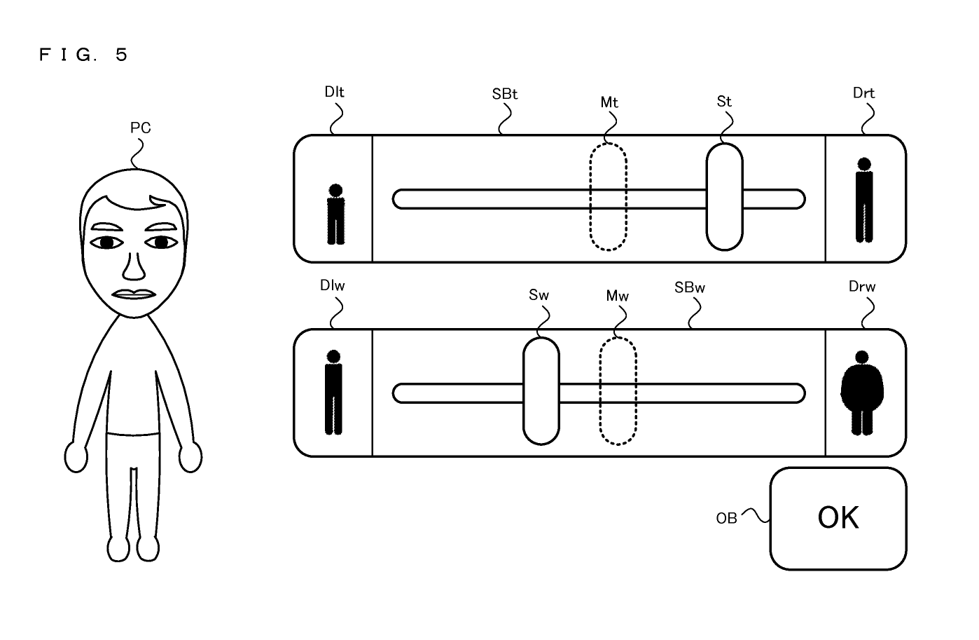

FIG. 5 shows an example of a build adjustment screen displayed when the build of the character image PC is adjusted. As shown in FIG. 5, a slider bar SBt and a slider bar SBw are displayed in parallel on the build adjustment screen, the slider bar SBt used to adjust the length (height) of the character image PC, the slider bar SBw used to adjust the thickness (weight) of the character image PC. The slider bars SBt and SBw have sliders St and Sw, respectively, each capable of moving in the left-right direction in accordance with the touch operation on the touch panel 341. It is possible to adjust the length and the thickness of the character image PC by moving the sliders St and Sw, respectively, in the left-right direction. Then, the character image PC is displayed on the build adjustment screen (FIG. 5) such that the build of the character image PC is changed in accordance with the left-right positions of the sliders St and Sw.

Here, in the slider bars SBt and SBw, marks Mt and Mw are displayed that indicate the positions of the sliders St and Sw, respectively, before the build of the character image PC is adjusted. For example, also the marks Mt and Mw are displayed as images representing the shadows of the sliders St and Sw, or the like, but may be images in other display forms so long as they are images distinguishable from the sliders St and Sw and capable of indicating the positions of the sliders St and Sw set in the past, respectively. As described above, by viewing the marks Mt and Mw, the user can easily know the settings made before the user themselves adjusts the build of the character image PC.

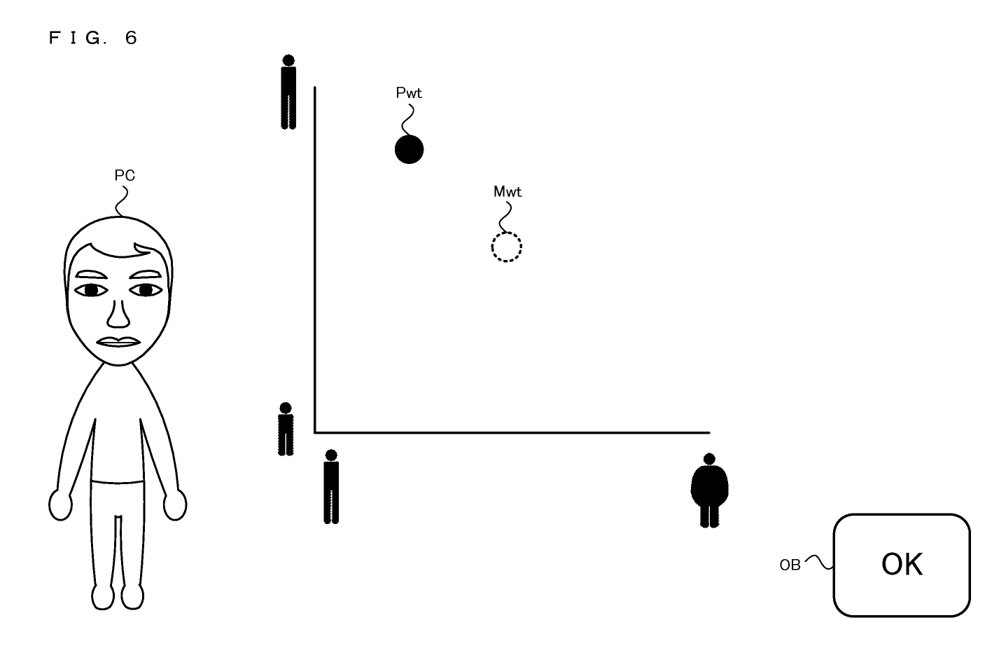

It should be noted that, in the build adjustment screen shown in FIG. 5, by way of example, the build (the length and the thickness) of the character image PC is adjusted using two slider bars to slide the respective operation handlers. Alternatively, as shown in FIG. 6, the build of the character image PC may be adjusted by representing the build in two dimensions. For example, a two-dimensional map is defined where the horizontal axis represents the thickness of the character image PC, and the vertical axis represents the length of the character image PC. Then, on the touch panel 341, an operation handler (a pointer Pwt) is displayed that is capable of moving in the up, down, left, and right directions in the two-dimensional map in accordance with the touch operation on the touch panel 341. Then, the thickness of the character image PC is adjusted in accordance with the position of the pointer Pwt in the left-right direction, and the length of the character image PC is adjusted in accordance with the position of the pointer Pwt in the up-down direction. Such an operation of the position of the pointer Pwt on the two-dimensional map makes it possible to simultaneously adjust the length and the thickness of the character image PC. Further, in the two-dimensional map, a mark Mwt is displayed that indicates the position of the pointer Pwt before the build of the character image PC is adjusted. For example, also the mark Mwt is displayed as an image representing the shadow of the pointer Pwt, or the like, but may be an image in another display form so long as it is an image distinguishable from the pointer Pwt and capable of indicating the position of the pointer Pwt set in the past.

In addition, the above description is given using the example where an operation target (the character image PC) is edited using a slider S capable of moving in the up-down direction, the left-right direction, or the like on a straight line, or a pointer P capable of moving in the up, down, left, and right directions on a plane. The tools used for editing, however, are not limited to these. For example, the operation target may be edited using a slider capable of moving on an arcuate gauge, or a pointer capable of moving in the up, down, left, right, front, and back directions in a three-dimensional space. Even if editing is performed using any tool, a slider or a pointer is displayed together with an image indicating the position of the slider or the pointer set in the past, respectively. This enables the user to easily know the setting made before the user themselves performs the editing, and also easily return the setting to that made before the adjustment. Alternatively, the operation target may be edited using a dial that rotates about an axis of rotation, or the like. In this case, the current angle of rotation of the dial is displayed together with an image indicating the angle of rotation of the dial set in the past. This enables the user to easily know the setting made before the user themselves performs the editing, and also easily return the setting to that made before the adjustment.

In addition, in the above description, a mark M indicates the setting made before the editing of the operation target using is started (typically, the setting determined in the previous editing or the like (as an example, the setting determined by the operation of selecting the OK button OB in the previous editing operation), or a default setting). Alternatively, the mark M may indicate another setting. For example, the mark M may indicate the setting tentatively determined while the user is performing the operation of editing the operation target (for example, the setting made when the user has moved the slider S or the pointer P by a touch operation and thereafter performed a touch-off operation). In this case, the position of the mark M is updated every time the setting is tentatively determined during the editing operation.

In addition, in the above description, during the editing operation, an image of the operation target adjusted by the editing operation is displayed. Alternatively, an image of the operation target created using the setting based on the position of the mark M may be further displayed. As described above, the simultaneous display of an image created by the previous editing or the like and an image adjusted by the current editing enables the comparison between the two images, and also makes it possible to facilitate the understanding of the state before the adjustment. It should be noted that the images of the two operation targets may be displayed in a superimposed manner. If, however, the images of the operation targets are displayed in a superimposed manner, the comparison between the states before and after the editing may be difficult to understand. Thus, if the images of the two operation targets are displayed, the images are preferably displayed in parallel.

In addition, in the above description, a single mark M indicates the setting made before the editing of the operation target is started. Alternatively, a plurality of marks may be provided to indicate a plurality of settings. For example, display is performed such that marks indicating the settings determined by the editing performed a plurality of times in the past are provided to a slider bar, a two-dimensional map, or the like. As an example, marks are displayed in display forms in which the order of the settings is distinguishable (for example, if marks M are represented by shadows, it is indicated that the deeper the shadow, the newer the setting), whereby it is possible to easily know a plurality of settings determined in the past, while the order of the settings is indicated. It goes without saying that, if the settings determined by the editing performed a plurality of times in the past are indicated, the operation target corresponding to each setting is displayed together with the setting, which makes it possible to further facilitate the understanding of each setting state.

In addition, the user moves the slider S or the pointer P to a position overlapping the mark M by a similar operation, and thereby can return an image of the operation target to the setting made before the user themselves performs the editing. Further, it is also possible to make the return operation easier. For example, the slider S and the pointer P may be configured to move to a position overlapping the mark M in accordance with the operation on another operation means included in the input section 34 (for example, a predetermined operation button), or a touch operation (a flick operation) of flicking the slider S or the pointer P, respectively, in the direction in which the mark M is placed.

In addition, the setting determined after the editing operation is performed is displayed as the mark M when the same part is edited again. If, however, the types of parts are changed, the mark M indicating the setting of the part before the change may be displayed when the part after the change is edited. As an example, if, with a first eye image PCe1 being already set as an editing target, an eye image to be employed for the character image Pc is changed to a second eye image PCe2, and the setting of the second eye image PCe2 (for example, the placement position, the placement direction, the size, the shape, or the like) is adjusted, the mark M indicating the setting already determined for the first eye image PCe1 is displayed on the corresponding adjustment screen.

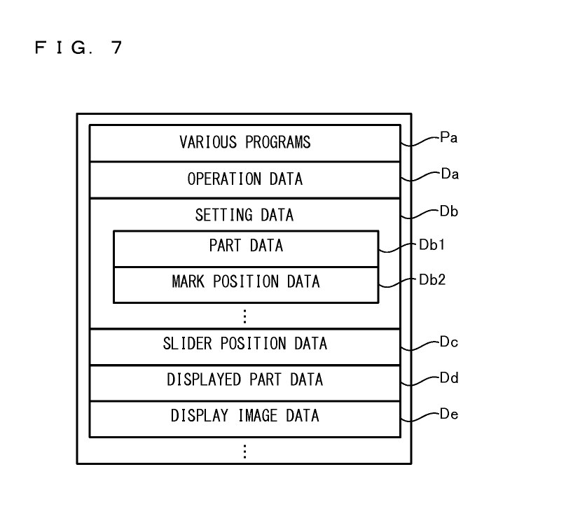

Next, a detailed description is given of the processing performed by the information processing apparatus 3. First, with reference to FIG. 7, main data used in the processing is described. It should be noted that FIG. 7 is a diagram showing examples of main data and programs stored in the storage section 32 of the information processing apparatus 3.

As shown in FIG. 7, the following are stored in the data storage area of the storage section 32: operation data Da; setting data Db; slider position data Dc; displayed part data Dd; display image data De; and the like. It should be noted that the storage section 32 may store, as well as the data shown in FIG. 7, data and the like necessary for the processing, such as data used in an application to be executed. Further, in the program storage area of the storage section 32, various programs Pa included in the image display program are stored.

The operation data Da is data representing the content of the operation performed on the input section 34, and includes data representing the touch position of the touch operation on the touch panel 341.

The setting data Db includes part data Db1, mark position data Db2, and the like. The part data Db1 is data representing the settings of each part determined by editing, and includes data representing default settings if editing is yet to be performed. The mark position data Db2 is data representing the position of a slider S determined by editing, with respect to each item of an editing menu of each part.

The slider position data Dc is data representing the display position of the slider S displayed so as to move in accordance with the operation on the touch panel 341 or the like.

The displayed part data Dd is data representing the settings of each part of the character image PC displayed on an editing screen, and is subsequently updated in accordance with the position of the slider S.

The display image data De is data for generating an image in which virtual objects, backgrounds, and the like such as a slider bar SB and the character image PC are placed, and displaying the image on the display section 35.

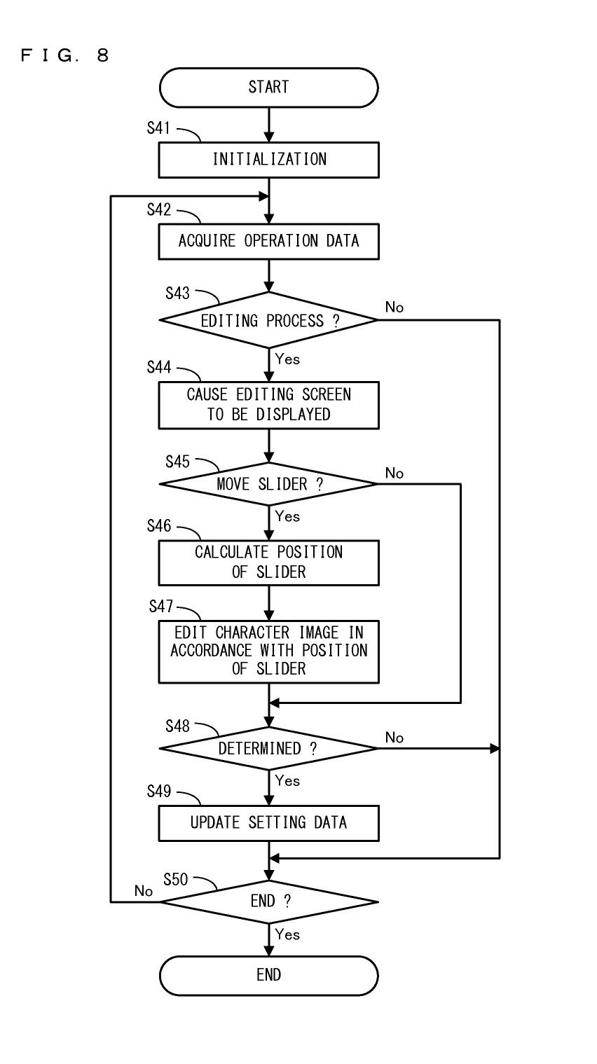

Next, with reference to FIG. 8, a detailed description is given of the processing performed by the information processing apparatus 3. It should be noted that FIG. 8 is a flow chart showing an example of the processing performed by the information processing apparatus 3. Here, in the flow chart shown in FIG. 8, descriptions are given mainly of, in the processing performed by the information processing apparatus 3, the process of editing the character image PC (the operation target) in accordance with the position of the slider. The detailed descriptions of other processes not directly related to these processes are omitted. Further, in FIG. 8, all the steps performed by the control section 31 are abbreviated as “S”.

The CPU of the control section 31 initializes a memory and the like of the storage section 32, and loads the image display program from the program storage section 33 into the memory. Then, the CPU starts the execution of the image display program. The flow chart shown in FIG. 8 is a flow chart showing the processing performed after the above processes are completed.

It should be noted that the processes of all the steps in the flow chart shown in FIG. 8 are merely illustrative. Thus, the processing order of the steps may be changed, or another process may be performed in addition to, and/or instead of, the processes of all the steps, so long as similar results are obtained. Further, in the exemplary embodiment, descriptions are given on the assumption that the control section 31 (the CPU) performs the processes of all the steps in the flow chart. Alternatively, a processor or a dedicated circuit other than the CPU may perform the processes of some or all of the steps in the flow chart.

Referring to FIG. 8, the control section 31 performs initialization (step 41), and proceeds to the subsequent step. For example, the control section 31 constructs a virtual world to be displayed on the display section 35, acquires data regarding the currently set character image PC, and initializes parameters. As an example, on the basis of the acquired data, the control section 31 initializes the part data Db1 and the displayed part data Dd to the same parameters, and initializes the mark position data Db2 and the slider position data Dc of each item of the editing menu on the basis of the parameters. Further, on the basis of the current settings (the part data Db1), the control section 31 causes the character image PC to be displayed on the display section 35, and causes a menu (options) for editing the character image PC to be displayed, thereby prompting the user to perform an editing operation.

Next, the control section 31 acquires operation data from the input section 34, updates the operation data Da (step 42), and proceeds to the subsequent step.

Next, the control section 31 determines whether or not the operation data acquired in the above step 43 indicates an editing process (step 43). For example, if the operation data indicates the operation of selecting an item of the menu (one of the options) for editing the character image PC, or an operation using various editing screens, the control section 31 determines that the operation data indicates an editing process. Then, if the operation data indicates an editing process, the control section 31 proceeds to step 44. If, on the other hand, the operation data does not indicate an editing process, the control section 31 proceeds to step 50.

In step 44, the control section 31 causes an editing screen to be displayed on the display section 35, and proceeds to the subsequent step. For example, in accordance with a user operation, the control section 31 causes an editing screen as shown in FIGS. 2 through 6 to be displayed on the display section 35. As an example, if a slider bar SB and the character image PC while being edited are displayed as an editing screen, a mark M is displayed at the position indicated by the mark position data Db2, a slider S is displayed at the position indicated by the slider position data Dc, and the character image PC is displayed on the basis of the settings indicated by the displayed part data Dd.

Next, the control section 31 determines whether or not the operation data acquired in the above step 43 indicates the operation of moving the slider (step 45). Then, if the operation data indicates the operation of moving the slider, the control section 31 proceeds to step 46. If, on the other hand, the operation data does not indicate the operation of moving the slider, the control section 31 proceeds to step 48.

In step 46, the control section 31 calculates the position of the slider corresponding to the operation data acquired in the above step 43, and proceeds to the subsequent step. For example, if the operation has been performed of moving the slider S by the touch operation on the touch panel 341, the control section 31 calculates as the position of the slider the position displayed on the display section 35 so as to overlap the touch position, and updates the slider position data Dc using the position of the slider.

Next, the control section 31 edits the character image PC in accordance with the position of the slider (step 47), and proceeds to step 48. For example, on the basis of the setting corresponding to the position of the slider calculated in the above step 46, the control section 31 changes the setting (for example, the placement position, the placement direction, the size, the shape, or the like) of the corresponding part in the character image PC, and updates the displayed part data Dd.

In step 48, the control section 31 determines whether or not a determination has been made on the edited setting. For example, if the operation data acquired in the above step 43 indicates the operation of selecting the OK button OB (see FIGS. 3 through 6), the control section 31 determines that a determination has been made on the edited setting. Then, if a determination has been made on the edited setting, the control section 31 proceeds to step 49. If a determination has not been made, the control section 31 proceeds to step 50.

In step 49, the control section 31 performs the process of updating the setting data Db, using the edited setting, and proceeds to step 50. For example, the control section 31 updates the mark position data Db2 regarding the editing, using the position of the slider indicated by the slider position data Dc. Further, the control section 31 updates the part data Db1, using the setting of the editing target in the displayed part data Dd.

In step 50, the control section 31 determines whether or not the processing is to be ended. Examples of conditions for ending the processing include: the satisfaction of the condition under which the processing is ended; the satisfaction of the condition under which the game is completed; and the fact that the user has performed the operation of ending the processing. If the processing is not to be ended, the control section 31 returns to the above step 42, and repeats the process thereof. If the processing is to be ended, the control section 31 ends the processing indicated in the flow chart.

It should be noted that the above descriptions are given using the character image PC representing a person, as the operation target to be edited. Alternatively, the operation target may be an image representing another object. In this case, a virtual object placed in a game world may be used as the operation target, and the exemplary embodiment may be used for the operation of adjusting the parameters of the virtual object. Specifically, the exemplary embodiment can be applied to the operation of, with a slider or a pointer, adjusting the angle of flight, the propulsion, and the like of a virtual object representing an airplane that flies in a game world. Alternatively, the operation target does not need to be an image. For example, the operation target may be an apparatus, a sound, or the like. As an example, the case is considered where an apparatus is the operation target. When the setting (the connection setting, the reception setting, the display setting, the sound setting, or the like) of a display apparatus or the like is adjusted by moving the position of a slider or a pointer, the previous setting is displayed as a mark, which makes it possible to provide similar effects. As another example, the case is considered where a sound is the operation target. When the adjustment of the balance, the timbre, the localization, the volume, or the like of the sound is made by moving the position of a slider or a pointer, the previous setting is displayed as a mark, which makes it possible to provide similar effects.

In addition, examples of the above operation of moving a slider or a pointer may include various forms. As a first example, in accordance with a touch operation of performing a drag, a slider or a pointer is moved to the position displayed so as to overlap the touch position. As a second example, in accordance with a touch operation of clicking a guide sign, a slider or a pointer is gradually moved to the guide sign. As a third example, in accordance with the operation on an operation button, a slide pad, or the like, a slider or a pointer is moved by a moving distance based on the length of time of the continuation of the operation performed in the direction corresponding to the operation, or based on the number of times of the operation.

In addition, the above descriptions are given using the example where the information processing apparatus 3 performs the image display process. Alternatively, another apparatus may perform at least some of the processing steps of the image display process. For example, if the information processing apparatus 3 is further configured to communicate with another apparatus (for example, a server), the other apparatus may cooperate to perform the processing steps of the image display process. As a possible example, another apparatus may receive data representing the editing operation of the user, and the other apparatus may perform the process of editing the character image PC. Another apparatus may thus perform at least some of the processing steps in the image display process, which enables an image display process similar to that described above. Further, the image display process described above can be performed by a processor or the cooperation of a plurality of processors, the processor and the plurality of processors contained in an image display system including at least one information processing apparatus.

Here, the above variations make it possible to achieve the exemplary embodiment also by a system form such as cloud computing, or a system form such as a distributed wide area network or a local area network. For example, in a system form such as a distributed local area network, it is possible to execute the game processing between a stationary information processing apparatus (a stationary game apparatus) and a handheld information processing apparatus (a handheld game apparatus) by the cooperation of the apparatuses. It should be noted that, in these system forms, there is no particular limitation on which apparatus performs the process of each step of the game processing described above. Thus, it is needless to say that it is possible to achieve the exemplary embodiment by sharing the processing in any manner.

In addition, the processing orders, the setting values, the conditions used in the determinations, and the like that are used in the image display process described above are merely illustrative. Thus, it is needless to say that the exemplary embodiment can be achieved also with other orders, other values, and other conditions.

In addition, the image display program may be supplied to the information processing apparatus 3 not only through an external storage medium, but also through a wired or wireless communication link. Further, the program may be stored in advance in a non-volatile storage device included in the information processing apparatus 3. It should be noted that examples of an information storage medium having stored therein the program may include CD-ROMs, DVDs, optical disk storage media similar to these, non-volatile memories, flexible disks, hard disks, magneto-optical disks, and magnetic tapes. Alternatively, an information storage medium having stored therein the program may be a volatile memory for storing the program. It can be said that such a storage medium is a storage medium readable by a computer or the like. For example, it is possible to provide the various functions described above by causing a computer or the like to load a program from the storage medium and execute it.

While some exemplary systems, exemplary methods, exemplary devices, and exemplary apparatuses have been described in detail above, the above descriptions are merely illustrative in all respects, and do not limit the scope of the systems, the methods, the devices, and the apparatuses. It is needless to say that the systems, the methods, the devices, and the apparatuses can be improved and modified in various manners without departing the spirit and scope of the appended claims. It is understood that the scope of the systems, the methods, the devices, and the apparatuses should be interpreted only by the scope of the appended claims. Further, it is understood that the specific descriptions of the exemplary embodiment enable a person skilled in the art to carry out an equivalent scope on the basis of the descriptions of the exemplary embodiment and general technical knowledge. It should be understood that, when used in the specification, the components and the like described in the singular with the word “a” or “an” preceding them do not exclude the plurals of the components. Furthermore, it should be understood that, unless otherwise stated, the terms used in the specification are used in their common meanings in the field. Thus, unless otherwise defined, all the jargons and the technical terms used in the specification have the same meanings as those generally understood by a person skilled in the art in the field of the exemplary embodiment. If there is a conflict, the specification (including definitions) takes precedence.

As described above, the exemplary embodiment is useful as, for example, an image display program, an image display apparatus, an image display system, an image display method, and the like in order, for example, to, when a setting of an operation target is made in accordance with an input of an operation, facilitate the understanding of the state before the setting is changed.

What is claimed is:

1. An image display apparatus for displaying on a display apparatus an image based on an input, the image display apparatus comprising:
an input reception unit configured to receive from an input apparatus an input provided by a user;
a current display position setting unit configured to, in accordance with the input, set a current display position of a slider to be displayed on the display apparatus;
a setting change unit configured to, in accordance with the current display position of the slider, change a setting of at least one of a placement position, a placement direction, a size, and a shape of at least one part forming a virtual object;
a past display position retention unit configured to retain a past display position of the slider used when the setting change unit has changed the setting; and
a display control unit configured to cause the slider to be displayed on the display apparatus at the current display position set by the current display position setting unit, and cause a past position image distinguishable from the slider to be displayed on the display apparatus at the past display position retained by the past display position retention unit.

2. A computer-readable storage medium having stored therein an image display program to be executed by a computer of an apparatus for displaying on a display apparatus an image based on an input, the image display program causing the computer to execute:
receiving from an input apparatus an input provided by a user;
in accordance with the input, setting a current display position of an operation handler image to be displayed on the display apparatus;
in accordance with the current display position of the operation handler image, changing a setting of information regarding an operation target to be operated by the user;
retaining a display position of the operation handler image used when the setting has been changed; and
causing the operation handler image to be displayed on the display apparatus at the current display position, and causing a past position image indicating at least one of the retained past display positions to be displayed on the display apparatus.

3. The computer-readable storage medium having stored therein the image display program according to claim 2, wherein
the operation target is a virtual object that is displayed on the display apparatus.

4. The computer-readable storage medium having stored therein the image display program according to claim 2, wherein
the operation target is allowed to be edited and/or created on the basis of the received input provided by the user.

5. The computer-readable storage medium having stored therein the image display program according to claim 2, wherein
an image representing the operation target indicating a result of changing the setting in accordance with the current display position of the operation handler image currently displayed on the display apparatus is further displayed on the display apparatus.

6. The computer-readable storage medium having stored therein the image display program according to claim 5, wherein
at least every time an input provided by the user is received, the image representing the operation target of which the setting has been changed in accordance with the input provided by the user is displayed on the display apparatus.

7. The computer-readable storage medium having stored therein the image display program according to claim 2, wherein
the operation target is formed of a plurality of parts;
the current display position of the operation handler image to be displayed on the display apparatus is set with respect to each of the plurality of parts;
the setting of information regarding the operation target is changed with respect to each of the plurality of parts;
the display position of the operation handler image used when the setting of the information has been changed is retained with respect to each of the plurality of parts; and
the operation handler image and the past position image corresponding to at least one of the plurality of parts are displayed on the display apparatus.

8. The computer-readable storage medium having stored therein the image display program according to claim 2, wherein
the retained display position is a position at which the operation handler image has been displayed when the user has changed the setting of the information regarding the operation target and thereafter confirmed the setting in the past.

9. The computer-readable storage medium having stored therein the image display program according to claim 2, the image display program further causing the computer to execute
in accordance with the input, confirming the changed setting of the information regarding the operation target, wherein
a display position of the operation handler image for obtaining the confirmed setting is retained; and
the past position image at the display position retained for the setting confirmed before the setting of the information regarding the operation target is changed is displayed together with the operation handler image on the display apparatus.

10. The computer-readable storage medium having stored therein the image display program according to claim 2, wherein
the past position image is an image distinguishable from the operation handler image.

11. The computer-readable storage medium having stored therein the image display program according to claim 2, wherein
the past position image is an image representing a mark of the operation handler image having been displayed.

12. The computer-readable storage medium having stored therein the image display program according to claim 2, wherein
in accordance with the input, the display position is moved on a two-dimensional plane displayed on the display apparatus; and
in accordance with the current display position, of the operation handler image, corresponding to two axes defined on the two-dimensional plane, a plurality of settings are changed for the information regarding the operation target.

13. The computer-readable storage medium having stored therein the image display program according to claim 2, wherein
in accordance with a predetermined input, the retained past display position is set as the current display position of the operation handler image.

14. The computer-readable storage medium having stored therein the image display program according to claim 2, wherein
the operation target is an operation target image that is displayed on the display apparatus; and
in accordance with the current display position of the operation handler image, a setting of at least one of a placement position, a placement direction, a size, and a shape of at least one part forming the operation target image is changed.

15. An image display system for displaying on a display apparatus an image based on an input, the image display system comprising:
an input reception unit configured to receive from an input apparatus an input provided by a user;
a display position setting unit configured to, in accordance with the input, set a current display position of an operation handler image to be displayed on the display apparatus;
a setting change unit configured to, in accordance with the current display position of the operation handler image, change a setting of information regarding an operation target to be operated by the user;
a display position retention unit configured to retain a display position of the operation handler image used when the setting has been changed; and
a display control unit configured to cause the operation handler image to be displayed on the display apparatus at the current display position set by the display position setting unit, and cause a past position image indicating at least one of the past display positions retained by the display position retention unit to be displayed on the display apparatus.

16. An image display method to be executed by a processor or a cooperation of a plurality of processors, the processor and the plurality of processors contained in a system including at least one information processing apparatus for displaying on a display apparatus an image based on an input, the image display method comprising:
receiving from an input apparatus an input provided by a user;
in accordance with the input, setting a current display position of an operation handler image to be displayed on the display apparatus;
in accordance with the current display position of the operation handler image, changing a setting of information regarding an operation target to be operated by the user;
retaining a display position of the operation handler image used when the setting has been changed; and
causing the operation handler image to be displayed on the display apparatus at the set current display position, and causing a past position image indicating at least one of the retained past display positions to be displayed on the display apparatus.
